(19) United States
(12) Patent Application Publication
(10) Pub. No.: US 2024/0028808 A1
(43) Pub. Date: Jan. 25, 2024

(54) METHOD AND DEVICE FOR CHIP LAYOUT, COMPUTER EQUIPMENT AND MEDIUM

(71) Applicant: CHINA GREAT WALL TECHNOLOGY GROUP CO., LTD., Shenzhen (CN)

(72) Inventors: Hongbin TU, Shenzhen (CN); Lufeng ZHANG, Shenzhen (CN); Xuan LI, Shenzhen (CN); Guang YI, Shenzhen (CN); Cheng LIAO, Shenzhen (CN); Xiyue ZHANG, Shenzhen (CN); Yi ZHENG, Shenzhen (CN); Yanqin WU, Shenzhen (CN); Haotian WANG, Shenzhen (CN); Chen GAO, Shenzhen (CN); Xiang ZHANG, Shenzhen (CN)

(21) Appl. No.: 18/223,779

(22) Filed: Jul. 19, 2023

(30) Foreign Application Priority Data
Jul. 20, 2022 (CN) 202210851852.6

(51) Int. Cl. G06F 30/392; G06F 30/27

(52) U.S. Cl. CPC G06F 30/392; G06F 30/27

(57) ABSTRACT

A method and a device for a chip layout, computer equipment, and a medium. The method includes steps of: determining external interfaces and internal interfaces of a chip, where the internal interface is a port of a component of the chip; constructing, according to the external interfaces and the internal interfaces, an objective function, where the objective function is applied to describe a wiring length of the chip; determining a target value of the objective function through a preset genetic algorithm, where the target value is applied to determine a first layout diagram of the chip; determining, based on an operation temperature of an internal chip as the component of the chip, a second layout diagram of the chip; performing an image fusion on the first layout diagram and the second layout diagram to obtain a target layout diagram of the chip.

### CROSS-REFERENCE TO RELATED APPLICATION

Pursuant to 35 U.S.C. § 119 and the Paris Convention, this application claims the benefit of Chinese Patent Application No. 202210851852.6 filed on Jul. 20, 2022, the content of which is incorporated herein by reference.

### TECHNICAL FIELD

The present application relates to the field of chip technology, and in particular, to a method and a device for a chip layout, computer equipment and a medium.

### BACKGROUND

The statements provided herein are merely background information related to the present application, and do not necessarily constitute any prior arts. Chips are an important part of a computer or other electronic devices. Chip layout is one of the most critical and time-consuming steps in a chip design process. In a layout task, various components in a netlist diagram (netlist) needs to be placed to corresponding positions on a chip board. The components may include macro elements (macro) such as flip-flops, arithmetic logic units, etc., and standard cells that are logic gates. A good layout result helps to improve the area utilization, time performance and wiring efficiency, etc. of the chip.

When performing a chip layout, it is necessary to comprehensively consider a wiring length of the chip and a temperature of the chip. At present, the temperature generated during operation of the chip and the wiring length of the chip are not taken into consideration during the chip layout.

### SUMMARY

In view of this, embodiments of the present application provide a method and a device for a chip layout, computer equipment and a medium, where both the operation temperature and the wiring length have been considered during the chip layout.

In accordance with a first aspect of the embodiments of the present application, a method for a chip layout is provided, which includes steps of: determining external interfaces and internal interfaces of a chip, where each of the internal interfaces is a port of a component of the chip; constructing an objective function according to the external interfaces and the internal interfaces, where the objective function is applied to describe a wiring length of the chip; determining a target value of the objective function through a preset genetic algorithm, where the target value is applied to determine a first layout diagram of the chip; determining a second layout diagram of the chip based on an operation temperature of an internal chip as the component of the chip; and performing an image fusion on the first layout diagram and the second layout diagram to obtain a target layout diagram of the chip.

In accordance with a second aspect of the embodiments of the present application, a device for a chip layout is provided, which includes a chip interface determination module, an objective function construction module, a first layout diagram determination module, a second layout diagram determination module and a target layout diagram determination module.

The chip interface determination module is configured to determine external interfaces and internal interfaces of the chip, and each of the internal interfaces being a port of a component of the chip.

The objective function construction module is configured to construct an objective function according to the external interfaces and the internal interfaces, and the objective function being applied to describe a wiring length of the chip.

The first layout diagram determination module is configured to determine a target value of the objective function through a preset genetic algorithm, and the target value being applied to determine a first layout diagram of the chip.

The second layout diagram determination module is configured to determine a second layout diagram of the chip based on an operation temperature of an internal chip as the component of the chip.

The target layout diagram determination module is configured to perform an image fusion on the first layout diagram and the second layout diagram to obtain a target layout diagram of the chip.

In accordance with a third aspect of the embodiments of the present application, computer equipment is provided, including a memory, a processor, and a computer program stored in the memory and executable by the processor. The processor, when executing the computer program, is configured to implement the method as above described in the first aspect.

In accordance with a fourth aspect of the embodiments of the present application, a computer-readable storage medium, in which a computer program is stored, and when the computer program is executed by a processor, the method described in the above-mentioned first aspect is implemented.

In accordance with a fifth aspect of the embodiments of the present application, a computer program product is provided, which, when running on computer equipment, causes the computer equipment to execute the method as above described in the first aspect.

Compared with the conventional arts, the embodiments of the present application include at least the following advantages:

In the embodiment of the present application, an objective function capable of measuring the wiring length is constructed through the external interfaces and the internal interfaces of the chip; the first layout diagram determined based on the objective function is a layout diagram determined based on the wiring length. The second layout diagram determined based on the operation temperature of the internal chip has taken into account the operation temperature of the chip. Therefore, both the wiring length and the operation temperature can be considered based on the target layout diagram obtained through an image fusion of the first layout diagram and the second layout diagram, so that the wiring length of the chip is shorter during layout, and the local temperature of the chip will not be too high when the chip is in operation.

### BRIEF DESCRIPTION OF DRAWINGS

In order to illustrate the technical solutions in the embodiments of the present application more clearly, the following will briefly introduce the drawings that are required in the description of the embodiments.

FIG. 1 is a schematic flowchart for steps of a method for a chip layout according to an embodiment of the present application;

FIG. 2 is a schematic diagram of a quasi-microphone array according to an embodiment of the present application;

FIG. 3 is a flowchart for obtaining a target value by utilizing a genetic algorithm according to an embodiment of the present application;

FIG. 4 is a heterogeneous graph attention network diagram according to an embodiment of the present application;

FIG. 5 is a schematic diagram of an adaptive weight allocation according to an embodiment of the present application;

FIG. 6 is a schematic diagram of an image fusion model according to an embodiment of the present application;

FIG. 7 is a schematic diagram of a device for a chip layout according to an embodiment of the present application; and

FIG. 8 is a schematic diagram of computer equipment according to an embodiment of the present application.

### DETAILED DESCRIPTION OF EMBODIMENTS

In the following description, specific details such as specific system structures and technologies are presented for the purpose of illustration rather than limitation, to facilitate a thorough understanding of the embodiments of the present application. It will be apparent, however, to persons skilled in the art that the present application may be practiced in other embodiments without these specific details. In other instances, detailed descriptions of well-known systems, devices, circuits, and methods are omitted so as not to obscure the description of the present application with unnecessary detail.

Before illustrating the layout method of the chip, the purpose of the chip layout is firstly introduced. Chip layout needs to determine the position of the components in the chip on the chip substrate. The chip may include multiple components, and the components may have one or more ports, and the ports need to be connected by wires. In the layout, it is necessary to determine suitable positions for the ports so that a wiring length is short. Some components of the chip may also be internal chips, and the internal chips, when in operation, will dissipate heat, resulting in an increase in temperature. In the chip layout, it is necessary to determine suitable positions for the internal chips to avoid excessive local temperature of the chip.

The method for the chip layout in the present application may determine suitable positions for the components in the chip in terms of the wiring length and the temperature. The technical solutions of the present application are illustrated below through specific embodiments.

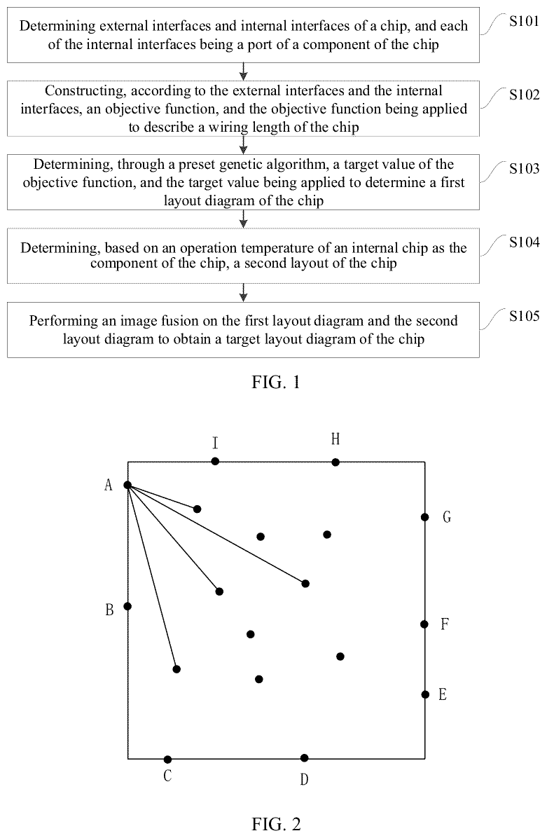

Referring to FIG. 1, which shows a schematic flowchart of steps of a method for a chip layout provided by an embodiment of the present application. An execution subject of the layout method in this embodiment may be computer equipment, including but not limited to a computer, a tablet computer, computer equipment, etc., or an industrial control terminal used for chip layout. The layout method may specifically include the following steps S101-S105.

In step S101, external interfaces and internal interfaces of a chip are determined, and each of the internal interfaces is a port of a component of the chip.

The chip may be laid out according to a chip design scheme. In the chip design scheme, functions and application scenarios of the chip as well as connection relationships of ports in the chip may be involved. According to the functions and application scenarios, the chip may have fixed external interfaces for input and output. According to the chip design scheme, the external interfaces may have definite fixed-point coordinates (XA, YA). The ports of components are the internal interfaces of the chip, and the positions of the internal interfaces need to be determined according to the method for the chip layout in the present application, so the internal interfaces have undetermined moving-point coordinates (Xb, Yb). Where, (XA, YA) and (Xb, Yb) are located in the same coordinate system, and the coordinate system can be determined according to the chip. For example, a two-dimensional coordinate system may be established using a vertex of the chip substrate as an origin coordinate, and since the size of the chip substrate is fixed, the moving-point coordinates (Xb, Yb) should be located in the area determined by the size of the chip substrate under the two-dimensional coordinate system.

When performing the chip layout, the components and input and output interfaces of the chip may be determined by computer equipment through the chip design scheme, thereby the internal and external interfaces of the chip are determined. For example, the description information and application scenarios of the input and output interfaces in the chip design scheme are readable by the computer equipment, the description information may include the number of input and output interfaces, and the layout position of the input and output interfaces may be determined according to the application scenarios. Component information in the chip design scheme is readable by the computer equipment, and the component information may include port information of components. Multiple internal interfaces in the chip may be determined according to the port information of the components.

When laying out the chip, input information from the user is also receivable by the computer equipment, and the input information may include layout positions of the external interfaces and the port information of the components. The computer equipment can determine the fixed-point coordinates of the external interfaces according to the layout positions of the external interfaces, and determine the moving-point coordinates of the internal interfaces according to the port information of the components.

In step S102, an objective function is constructed according to the external interfaces and the internal interfaces, where the objective function is applied to describe a wiring length.

According to the chip design scheme, corresponding connection relationships between an internal interface and an external interface or between two internal interfaces are provided. Interfaces having a connection relationship are connected through wires when laying out the chip. In the chip layout, in order to save material, a smaller wiring length is required. The value of the wiring length may be measured through the above objective function. That is, the larger the value of the objective function, the longer the wiring; the smaller the value of the objective function, the shorter the wiring.

Based on the connection relationship between the interfaces of the chip, the objective function may be constructed. In a possible implementation, the objective function may be a sum of distances between coordinates of interfaces having a connection relationship. For example, in case that the chip includes external interfaces A, B, C, D and internal interfaces X1, X2, X3. . . Xn, if A, B, C, D are respectively connected to X1, X2, X3. . . Xn, then the objective function may be expressed as follows:

$$F = {\sum }_{j = 1}^{4} {\sum }_{i = 1}^{n} \sqrt{{( XjA - Xib )}^{2} + {( YjA - Yib )}^{2}}$$

Where, (XjA, YjA) is a fixed-point coordinate of a j-th external interface, and (Xib, Yib) is a moving-point coordinate of an i-th internal interface.

In another possible implementation, the above objective function may be determined through a quasi-microphone array model. A microphone array is actually a sound collection system that uses multiple microphones to collect sounds from different spatial directions. FIG. 2 is a schematic diagram of a quasi-microphone array provided by an embodiment of the present application. The quasi-microphone array is constructed based on the external interfaces and internal interfaces of the chip. As shown in FIG. 2, A-F are external interfaces located at the edge of the chip substrate. The chip substrate also includes multiple internal interfaces, and the interfaces are in connection. For example, the external interface A is connected to four internal interfaces. In this quasi-microphone array, the position coordinates of A-F are determined, but the positions of the internal interfaces are uncertain.

In the quasi-microphone array model of this embodiment, the external interfaces may be used as sound sources and the internal interfaces may be used as microphones, so that the same principle as the microphone array can be used to construct an objective function for measuring the wiring length. The constructed objective function may be expressed as follows:

$$F = {\sum }_{j = 1}^{n} {H}_{j} {\sum }_{i = 1}^{n} Kji τ ji \\ τ ji = \frac{\sqrt{{( XjA - Xib )}^{2} + {( YjA - Yib )}^{2}}}{c}$$

Wherein, F is the objective function; Kji is a weighting coefficient of the j-th external interface and the i-th internal interface, and τji is a time duration lasting from a time when the j-th external interface sends out a sound to a time when the i-th internal interface receives the sound; (XjA, YjA) is the fixed-point coordinate of the j-th external interface, (Xib, Yib) is the moving-point coordinate of the i-th internal interface, c is a speed of sound; Hⱼ is an utilization rate of the j-th external interface.

The above weighting coefficient Kji may be determined according to a connection relationship between the internal interface and the external interface. For example, if the external interface is directly connected to the internal interface, then the weighting coefficient is 1. If the external interface, instead of being directly connected to the internal interface, is connected to other interfaces of the component to which the internal interface belongs, then the weighting coefficient is 0.8. If the interface, instead of being directly connected to the internal interface, is connected to the internal interface through another component, then the weighting coefficient is 0.4. If the external interface and the internal interface are neither directly connected, nor indirectly connected, then the weighting coefficient can be determined to be 0. In a possible implementation, a preset weighting coefficient determination rule may be stored in the computer equipment, and the computer equipment is enabled to read the connection relationship between the internal interface and the external interface from the chip design scheme, and to determine a corresponding weighting coefficient according to the connection relationship and the weighting coefficient determination rule.

The interfaces in the chip have different utilization rates, and more attention may be paid to interfaces having high utilization rates during layout. The utilization rate of each external interface in the chip can be determined according to the chip design scheme. Then the value of Hⱼ of this external interface having the highest utilization is determined as 1; the value of Hⱼ of another interface may be a ratio of a utilization of the other interface to the highest utilization.

In step S103, a target value of the objective function is determined through a preset genetic algorithm, where the target value is applied to determine a first layout diagram of the chip.

Genetic algorithm is an optimization algorithm designed to simulate the survival of the fittest in nature, and also is an adaptive global optimization algorithm. The genetic algorithm in this embodiment may be a niche genetic algorithm. When using the genetic algorithm, the corresponding population may be determined, and the population may include multiple individuals, and each individual has a sharing degree value and a fitness value. The formulas for determining the sharing degree value and fitness value may be expressed as follows:

$${m}_{i} = {\sum }_{j = 1}^{N} sh ( {d}_{ij} ) \\ ( i = 1 , 2 , … , N ) \\ {f}_{i}^{′} = \frac{{f}_{i}}{{m}_{i}} \\ sh ( {d}_{ij} ) = 1 - \frac{{d}_{ij}}{{σ}_{share}} ( dij < {σ}_{share} )$$

Where, N is an individual tree, representing a size of population; fᵢ is a fitness value of an individual i; σₛₕₐᵣₑ is a shared parameter, that is, an expected value of a distance between individuals, and in this embodiment, σₛₕₐᵣₑ may be the minimum distance between the ports of components; mᵢ is a sharing degree value of the i-th individual, f′ᵢ is a sharing fitness value of the i-th individual; dᵢⱼ is a distance between the i-th individual and the j-th individual, and sh(dᵢⱼ) is 0 when dᵢⱼ>σ_{share.}

In the genetic algorithm, the population is iterated continuously, so that the fitness value of the individual can change. In the process of genetic iteration, better results are retained, and relatively poor results are regenerated to new results. The population in the genetic algorithm can simulate the process of the survival of the fittest in the biosphere, so as to optimize based on the set selection criteria. In this embodiment, the selection criterion may be an objective function.

The corresponding relationship between the genetic algorithm model and the chip layout and implementations of the chip layout may be shown in the following table:

| Genetic | | |
|---|---|---|
| Algorithm | Chip Array | Implementations |
| Gene | Coordinate of an interface | Position of an element |
| | of a component | in an array |
| Chromosome | Interface of the component | Element in the array |
| Individual | Component | All interfaces of a single |
| | | component |
| Population | Overall layout | All interfaces |

Based on the above correspondence, the data in the genetic algorithm may be associated with the data in the quasi-microphone array model, so that the genetic algorithm can be used to determine the target value of the objective function. The above-mentioned target value is an optimal value of the objective function, and the target value may correspond to an arrangement of internal interfaces, and the arrangement may correspond to a smaller wiring length.

Genetic algorithms may include genes, individuals, and populations. In this embodiment, the overall layout of the chip may be regarded as a population, the components may be regarded as individuals in the population, and the position of an internal interface may be regarded as the gene of the individual. After the population is determined, population iteration may be realized through a population variation. Genetic mutations occur during a variation of population. The genetic mutations may be equivalent to variations of the moving-point coordinates of the internal interfaces. A value of a new objective function may be determined after a change of the moving-point coordinates is occurred. In the population iteration process, each population may determine a value of an objective function, and the minimum value of the objective function may be used as the target value. Then, the first layout diagram is generated according to the moving-point coordinates of the internal interfaces corresponding to the target value.

Specifically, an initial population of a genetic algorithm is established with components as individuals and ports as individual genes, and the genetic algorithm may have a corresponding mutation probability and an iteration stop rule. The initial population is controlled to perform population iteration according to the mutation probability, thereby multiple intermediate populations are obtained. For the initial population and each intermediate population, a corresponding value may be obtained respectively by substituting the moving-point coordinates of each port into a calculation formula of the objective function. The minimum value is taken as the target value, and then the moving-point coordinates of each port under the target value are determined. Based on the moving-point coordinates of each port, the first layout diagram can be drawn. The first layout diagram may be a line diagram, including the position and connection relationship of each internal interface and each external interface.

The iteration stopping rule is applied to judge whether to stop the population variation or not. For example, the iteration rule may include a preset number of iterations, and when the number of iterations is reached, the population variation is stopped. In addition, whether to stop the population variation may also be determined according to a variation rate of the objective function between two generations. For example, the variation rate may be expressed as: |F-F′|/F, where F is a value of the objective function corresponding to a current population, and F′ is a value of the objective function corresponding to a previous generation of the current population. The population variation may be stopped when the variation rate reaches a preset value.

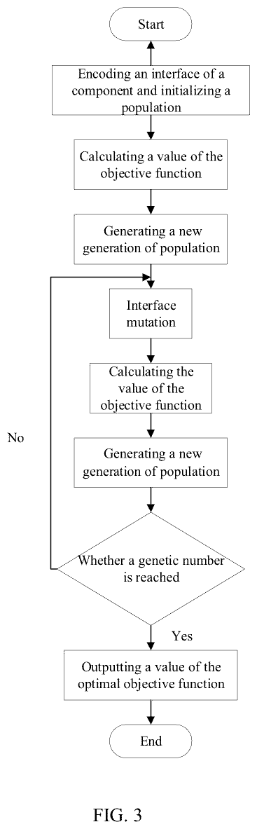

FIG. 3 is a flowchart for obtaining a target value using a genetic algorithm provided by an embodiment of the present application. As shown in FIG. 3, the coding of the component interfaces may be determined, and the population may be initialized. Then the value of the objective function is calculated under the initialized population. Afterwards, the population is mutated to generate a new generation of population. In the new generation of population, the moving-point coordinates of interfaces of the chip are mutated; and the value of the objective function is calculated based on the mutated interfaces. Continuously, a new generation of the population is generated, then it is judged whether the population variation has reached the genetic times. If the number of iterations is reached, then the optimal value of the objective function may be determined, and the population variation is ended. The optimal value is the target value, namely, the minimum value of the objective function.

In this embodiment, it should be ensured that the moving-point coordinates are located within the area determined by the chip substrate when changing the moving-point coordinates of the internal interfaces.

In step S104, a second layout diagram of the chip is determined based on an operation temperature of an internal chip as the component of the chip.

Some components in the chip may be internal chips. For example, in a FPGA chip, many other chips having simple functions will be used. Internal chips will generate heat during operation. If the arrangement of multiple internal chips is relatively concentrated, a local temperature of the chip may be too high during operation. Excessive local temperature of the chip will affect the performance of the chip, and may cause the chip to burn out in severe cases. Therefore, it is necessary to layout each internal chip according to the operation temperature to avoid over-concentrated heat distribution.

In a possible implementation, the maximum operation temperature of each internal chip within a preset time may be determined, and then the internal chips are deployed based on the maximum operation temperature. For example, the chip substrate may be divided into multiple regions, and then the sum of the maximum operation temperatures of the internal chips in each region may be calculated. When the sum of the maximum operation temperatures corresponding to each region in the chip substrate is less than the preset value, the corresponding deployment of the internal chips can be determined, thereby a second layout diagram is determined.

In another possible implementation, in the present application, a heterogeneous graph attention model (HAN) may be used to determine the position of the internal chips. The heterogeneous graph attention model is a feature optimization algorithm, and FIG. 4 is a diagram showing a heterogeneous graph attention model provided by an embodiment of the present application. As shown in FIG. 4, multiple nodes can be included in the heterogeneous graph attention model, and bidirectional arrows between the nodes indicates that the nodes can influence each other. In this embodiment, the operation temperature of one internal chip comes from the heat generated during its own operation on the one hand, and is affected by the operation temperature of other internal chips on the other hand. That is, temperature influences based on distances between internal chips are existed, thus, the internal chips can be used as nodes to construct a heterogeneous graph attention model, so that the heterogeneous graph attention model can be used to optimize the position of the internal chips to avoid excessive local temperature of the chip.

When using the heterogeneous graph attention model to optimize the layout for positions of the internal chips, the following steps may be included that the heterogeneous graph attention model may be trained first; then input parameters of the heterogeneous graph attention model is determined according to the operation temperatures of the internal chips being some components of the chip and the initial positions of the internal chips; and then the input parameters are input into the heterogeneous graph attention model to obtain target positions of the internal chips; and a second layout diagram is generated according to the target positions. The initial positions of the internal chips maybe arranged randomly, or may be determined according to the first layout diagram.

Before training the heterogeneous graph attention model, a data preprocessing may be performed on training data. In terms of a temperature prediction on chip, the position information of each chip is static data, while the temperature of each chip is dynamic sequence data. Therefore, a proper integration of these heterogeneous data is required.

Firstly, a data annotation operation is carried out. The present application adopts the Z-score standardization method using an average value mean (·) and an average standard deviation std (·) for processing. The updated sequence data is calculated as follows:

$${m}^{′} = \frac{m - mean ( m )}{std ( m )}$$

Where m′ is a chip temperature T, then, a value of T is calculated every 5 minutes and a series m′ is generated over an hour, e.g., X=x₁, x₂, . . . , xₜ Next, the position information of all interfaces are concatenated into the sequence. Finally, a nonlinear transformation is performed, which is expressed as follows:

f(x)=LeakyReLU(xW+b)

Where, W and b are learnable parameters, and LeakyReLU is an activation function.

Then, a time convolutional network (TCN) is utilized to process the above sequence, and the following method for data processing is adapted:

hₖ=tanh(W_{f,k -1}*xₖ₋₁)⊙σ(W_{g,k -1}*xₖ₋₁)

Where, σ is a logistic nonlinear sigmoid function, ⊙ represents a dot product between elements, tanh is a hyperbolic function; k is a time node; hₖ is an output vector of each node at each time step.

In terms of temperature of the chip, an internal chip Ci as a node will have an impact on the temperature of other internal chips such as C₁, C₂, and vice versa. So, the heterogeneous graph attention model built on internal chips has edges and one type of nodes.

To take into account the direct distance between different chips, a weight of an edge in the graph is calculated according to distances relative to the edge in this embodiment. The max-min normalization function may be used to set an initial weight value x′

$${x}^{′} = \frac{x - min ( x )}{max ( x ) - min ( x )}$$

G=(V,E, Ov,RE) represents a graph structure having multiple flow features. In graph G, V is a vertex, E is an edge, Ov is a type set of nodes, that is, a set of internal chips; RE is an edge, such as chip 1-chip 2, chip 2-chip 1, chip 1-chip 3.

In this embodiment, based on the graph relational network, the hidden self-attention layer of graph attention networks (GATs) is utilized to operate on graph-structured data. In the GAT model, the attention weight coefficients aᵢⱼ of nodes Cᵢ and Cⱼ may be expressed as follows depending on features:

$${α}_{ij} = \frac{exp ( Leaky ReLU ( {a}^{T} [ {Wh}_{i} ∥ {Wh}_{j} ] ) )}{{\sum }_{k ∈ {N}_{i}} exp ( Leaky ReLU ( {a}^{T} [ {Wh}_{i} ∥ {Wh}_{k} ] ) )}$$

Where, Nᵢ represents a collection of all nodes related to the node, and ∥ represents a splicing operation of the vector, hᵢ, hⱼ represents initial features of node i and node j, and a is a trainable weight vector.

Based on the above, the necessary input parameters X: =(x₁, x₂, xₜ), G=(V,E,Oᵥ,RE) for the training of the heterogeneous graph attention model can be determined, these two input parameters represent a time series in terms of the t time steps and the heterogeneous graph, respectively. A 3D vector of t time steps consisting of N features of n nodes having a vector dimension (t,N,n) and a heterogeneous graph consisting of n nodes: X: =(x₁, x₂, . . . , xₜ) and G=(V,E,Oᵥ,RE).

Operations of the data preprocessing may be performed according to the above data preprocessing steps after the input parameters are determined. A module initialization of the heterogeneous graph attention model may be performed after the data preprocessing is completed.

To initialize the module, firstly, in a fully-connected module (FC module), the function f(x) is input through a transmission of a convolutional layer having a convolution kernel size of 1×1, and then is activated by using LeakyReLU. Secondly, in the TCN module, an output from the FC module is activated by the sigmoid and tanh functions respectively through a filter convolution and a gate convolution. Finally, in the GAT module, an output of the TCN module and the heterogeneous graph mentioned above are received to discover a correlation of the data. In the process of model training, an Adam algorithm is applied to optimize the gradient descent process.

During training, the training data for each training may be decomposed into trainX and trainY, and then trainX is sent to the HAN model after a normalization and an addition of bias is applied. Finally, the predictions are inverted and the loss is computed together with trainY. Temporal attention module and heterogeneous graph attention module are two important components of this model. After each training is completed, a three-dimensional vector composed of the temperature of N nodes of size (t, N, 1) in t time steps can be obtained:

Ŷ=(ŷ₁, ŷ₂, . . . , ŷ)

Then it is determined whether the three-dimensional vector satisfies requirements of temperature arrangement, and if the three-dimensional vector satisfies the requirements of the temperature arrangement, it is determined that the training is completed. The trained model is applied to optimize the location of the internal chips.

In another possible implementation, the heterogeneous graph attention model may be trained for temperature prediction after a temperature chip layout. That is, multiple layouts of the internal chips may be determined. In each layout, a heat map of the chip during operation is determined based on the trained heterogeneous graph attention model; and from multiple heat maps, a target heat map having the least concentration of heat is determined. The second layout diagram is determined according to a layout mode corresponding to the target heat map.

In step S105, an image fusion on the first layout diagram and the second layout diagram to obtain a target layout diagram of the chip.

In this embodiment, the first layout diagram and the second layout diagram may be fused through an image fusion model based on a multi-attention module.

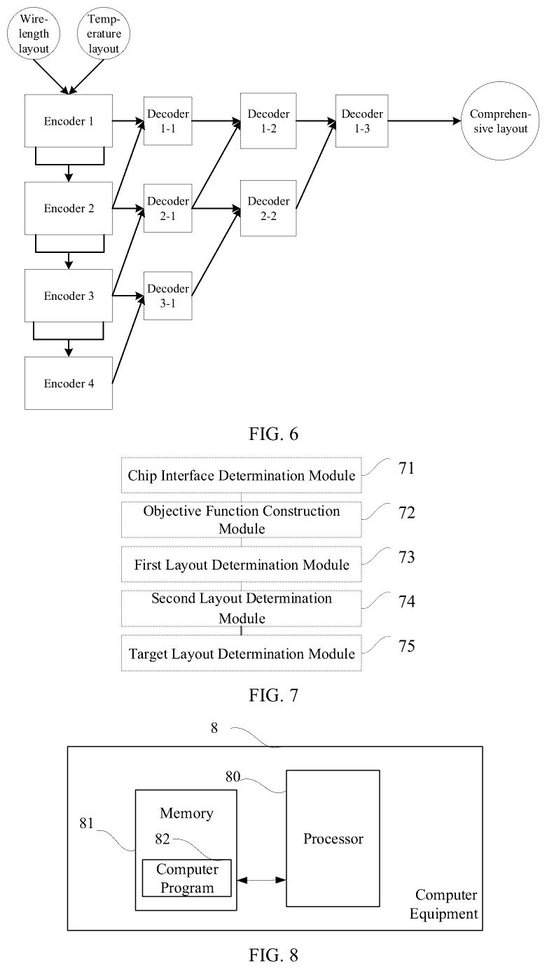

FIG. 6 is a schematic diagram of an image fusion model provided by an embodiment of the present application. In FIG. 6, a wiring length layout is the first layout diagram, and a temperature layout is the second layout diagram. The image fusion model may include multiple decoders and multiple encoders, and in FIG. 6, only 4 encoders and 6 decoders are shown. The decoder may be used for feature extraction, and the encoder may reconstruct a fusion feature into an image. In addition, the image fusion model may also include an ICS (IMS Centralized Services) block, and the ICS block may be used for a feature fusion. The process of image fusion using the image fusion model in FIG. 6 may be as follows: the feature channels of the first layout diagram and the second layout diagram of the three channels are respectively expanded, and the first layout diagram and the second layout diagram are expanded to 64 feature channels, to obtain a first target feature map and a second target feature map. Then the encoder in the image fusion model is applied to extract a first feature and a second feature from the first target feature map and the second target feature map respectively. Then, the ICS block is used to fuse the first feature and the second feature to obtain the fusion feature. Afterwards, the fusion features are input into the decoders of the image fusion model to obtain a comprehensive layout diagram after fusion. The comprehensive layout diagram is the optimal layout obtained by combining the two factors of wiring length and temperature.

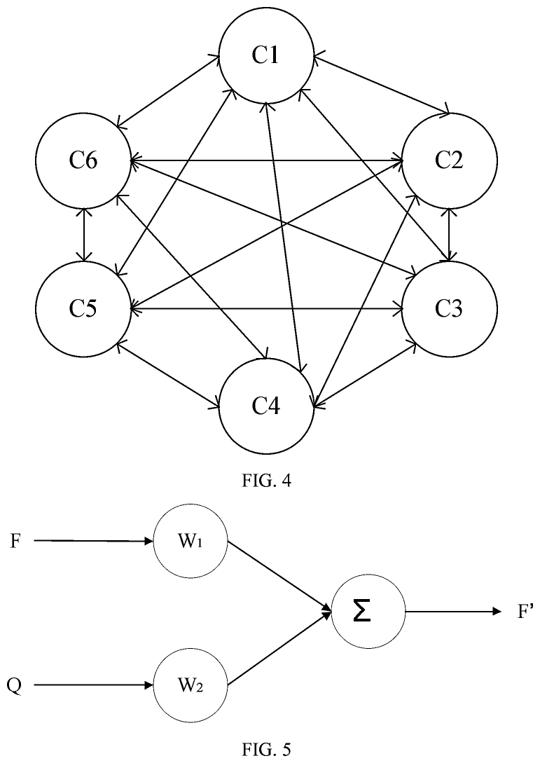

In this embodiment, when performing an image fusion, an adaptive weighted data fusion algorithm may be used. Therefore, before performing the image fusion, a first weighted value of the first layout diagram and a second weighted value of the second layout diagram may be determined first. FIG. 5 is a schematic diagram of an adaptive weight allocation provided by an embodiment of the present application, wherein F is the objective function, Q is an average temperature difference, and F′ is a characteristic value of a weighted layout diagram. According to FIG. 5, the determining formula of the first weighted value and the second weighted value may be expressed as follows:

w₁+w₂=1

F′=Fw₁+Qw₂

σ²=(w₁σ₁)²+(w₂σ₂)²

Where, w₁ is the first weighted value, and w₂ is the second weighted value; σ₁ is a variance of the value of the objective function corresponding to the first layout diagram; and a σ₂ is a variance of the value of the objective function value corresponding to the second layout diagram.

A loss function of the image fusion model may be determined based on the first weighted value and the second weighted value. The loss function can be used to determine an effect of image fusion. The loss function may be expressed as follows:

$$L = {w}_{1} {L}_{l} + {w}_{2} {L}_{t} \\ {L}_{1} = \frac{1}{H \times W} {‖ {I}_{i} - {I}_{f} ‖}_{F}^{2} \\ {L}_{t} = 1 - SSIM ( O , I )$$

Where, L is a value of the loss function, L₁ is a loss value of the first layout diagram, and Lₜ is a loss value of the second layout diagram, H and W are a height and a width of a source image, respectively. Iᵢ and I_{f} are an original pseudo-color image and a fused image that are input. ∥·∥_{F} is the Frobenius norm. SSIM represents a measurement of structural similarity. I and O represent an input image and an output image, respectively.

The image fusion model may have parameters, and different fusion results may be obtained by adjusting the values of the parameters. Based on a number of different parameters, the image fusion model may be trained multiple times using the first layout diagram and the second layout diagram to obtain multiple comprehensive layout diagrams; then the loss value of the loss function is calculated after each training; and then the comprehensive layout diagram corresponding to the minimum loss value is determined as the target layout diagram. The chip is laid out according to the target layout diagram, which can not only shorten the wiring length, but also avoid excessive local temperature.

In this embodiment, when the chip layout is determined based on the wiring length, the ports are weighted based on the utilization rate of each port of the chip, thereby the purpose of prioritizing layout and wiring of ports having high utilization rate is achieved. The quasi-microphone array model is optimized based on the genetic optimization algorithm, thereby a wiring layout that shortens the wiring length is determined. Meanwhile, a temperature layout for the internal chips is predicted based on the heterogeneous graph attention model, thereby a temperature layout having reasonable temperature distribution is determined. An integration of wiring layout and temperature layout enables the chip to take into account the wiring length and operation temperature during layout, and avoid excessive heat concentration while shortening the wiring length.

It should be noted that the sequence numbers of the steps in the above embodiments do not mean the order of execution, the execution order of each process should be determined by functions and internal logic of these processes, and shall not constitute any limitation of the implementation process of the embodiments of the present application.

Referring to FIG. 7, a schematic diagram of a device for a chip layout provided by an embodiment of the present application is shown, the device may specifically include a chip interface determination module 71, an objective function construction module 72, a first layout diagram determination module 73, and a second layout diagram determination module. 74 and a target layout diagram determination module 75.

The chip interface determining module 71 is configured to determine external interfaces and internal interfaces of a chip, and each of the internal interfaces is a port of a component of the chip;

The objective function construction module 72 is configured to construct an objective function according to the external interfaces and the internal interfaces, and the objective function is applied to describe a wiring length of the chip.

The first layout diagram determination module 73 is configured to determine a target value of the objective function through a preset genetic algorithm, and the target value is applied to determine a first layout diagram of the chip.

The second layout diagram determination module 74 is configured to determine a second layout diagram of the chip based on an operation temperature of an internal chip as the component of the chip.

The target layout diagram determining module 75 is configured to perform an image fusion on the first layout diagram and the second layout diagram to obtain a target layout diagram of the chip.

In a possible implementation, the above objective function construction module 72 includes a sub-module for constructing a quasi-microphone array model and a sub-module for establishing the objective function.

The sub-module for constructing a quasi-microphone array model is configured to construct a quasi-microphone array model by using each of the internal interfaces as an internal moving point and each of the external interfaces as an edge fixed point.

The sub-module for establishing the objective function is configured to establish the objective function based on a sound receiving time between the edge fixed point and the internal moving point in the quasi-microphone array model.

In a possible implementation, the objective function may be expressed as follows:

$$F = {\sum }_{j = 1}^{n} {H}_{j} {\sum }_{i = 1}^{n} Kji τ ji \\ τ ji = \frac{\sqrt{{( XjA - Xib )}^{2} + {( YjA - Yib )}^{2}}}{c}$$

Wherein, F is the objective function; Kji is the weighting coefficient of the j-th external interface and the i-th internal interface, and τji is a time duration lasting from a time when the j-th external interface sends out a sound to a time when the i-th internal interface receives the sound; (XjA, YjA) is the fixed-point coordinate of the j-th external interface, (Xib, Yib) is the moving-point coordinate of the i-th internal interface, c is the speed of sound; Hⱼ is the utilization rate of the j-th external interface.

In a possible implementation, the first layout diagram determination module 73 includes a population establishment sub-module, a population variation sub-module, a calculation sub-module, a target value determination sub-module, a moving-point coordinate value determination sub-module, and a first layout diagram generation sub-module.

The population establishment sub-module is configured to establish an initial population of a genetic algorithm with the component as an individual and the port as a gene of the individual, and the genetic algorithm has a corresponding mutation probability and an iteration stop rule.

The population variation sub-module is configured to mutate the initial population multiple times according to the mutation probability and the iterative stop rule to obtain multiple intermediate populations.

The calculation sub-module is configured to calculate the value of the objective function corresponding to the initial population and the multiple intermediate populations.

The target value determination sub-module is configured to determine a minimum value of the objective function as a target value.

The moving-point coordinate value determination sub-module is configured to determine a moving-point coordinate corresponding to the port based on the target value;

The first layout diagram generation sub-module is configured to generate the first layout diagram based on the moving-point coordinate.

In a possible implementation, the second layout diagram determination module 74 includes a training sub-module, an input parameter determination sub-module, an output sub-module, and a second layout diagram generation sub-module.

The training sub-module is configured to train a heterogeneous graph attention model.

The input parameter determination sub-module is configured to determine input parameters of the heterogeneous graph attention model according to the operation temperature of the internal chip as the component of the chip and an initial position of the internal chip.

The output sub-module is configured to input the input parameters into the heterogeneous graph attention model to obtain a target position of the internal chip.

The second layout diagram generating sub-module is configured to generate the second layout diagram according to the target position.

In a possible implementation, the target layout diagram determining module 75 includes a weight determination sub-module, a loss function determination sub-module, a fusion sub-module, a loss value calculation sub-module and a target layout diagram determination sub-module.

The weight determination sub-module is configured to determine a first weighted value of the first layout diagram and a second weighted value of the second layout diagram.

The loss function determination sub-module is configured to determine a loss function of an image fusion model based on the first weighted value and the second weighted value;

The fusion sub-module is configured to train the image fusion model multiple times by using the first layout diagram and the second layout diagram to obtain multiple comprehensive layout diagrams;

The loss value calculation sub-module is configured to calculate a loss value of the loss function after each training.

The target layout diagram determination sub-module is configured to determine a comprehensive layout diagram corresponding to the minimum loss value as the target layout diagram.

In a possible implementation, the fusion sub-module includes a feature expansion unit, a feature extraction unit, a feature fusion unit, and a decoding unit.

The feature expansion unit is configured to perform a feature channel expansion on the first layout diagram and the second layout diagram to obtain a first target feature map and a second target feature map, respectively.

The feature extraction unit is configured to extract a first feature and a second feature respectively from the first target feature map and the second target feature map using an encoder in the image fusion model.

The feature fusion unit is configured to perform a fusion on the first feature and the second feature to obtain a fusion feature.

The decoding unit is configured to input the fusion feature into a decoder in the image fusion model to obtain a comprehensive layout diagram after fusion.

As for the device embodiment, since the device embodiment is basically similar to the method embodiment, the description is relatively simple, and for related details, please refer to the description of the method embodiment.

FIG. 8 is a schematic structural diagram of computer equipment provided by an embodiment of the present application. As shown in FIG. 8, the computer equipment 8 of this embodiment includes: at least one processor 80 (only one processor, is shown in FIG. 8), a memory 81 and a computer program 82 stored in the memory 81 and executable by the at least one processor 80. The computer program 82, when executed by the processor 80, causes the processor to implement the steps in any of the above method embodiments.

The computer equipment 8 may be a computing device such as a desktop computer, a notebook, a palmtop computer, or a server. The computer equipment may include, but is not limited to, a processor 80 and a memory 81. Those skilled in the art can understand that FIG. 8 is only an example of computer equipment 8, and does not constitute a limitation to computer equipment 8. The computer equipment 8 may include more or less components than those shown in the figure, or a combination of certain components, or different components. For example, the computer equipment 8 may also include input and output devices, network access devices, and so on.

The processor 80 may be a central processing unit (CPU), and the processor may also be other general processors, a digital signal processor (DSP), an application specific integrated circuit (ASIC), a field-programmable gate array (FPGA) or other programmable logic devices, discrete gate or transistor logic devices, discrete hardware components, etc. A general-purpose processor may be a microprocessor, or the processor may be any conventional processor, or the like.

The storage 81 may be an internal storage unit of the computer equipment 8 in some embodiments, such as a hard disk or a memory of the computer equipment 8. The memory 81 may also be an external storage device of the computer equipment 8 in other embodiments, such as a plug-in hard disk equipped on the computer equipment 8, a smart media card (SMC), a secure digital (SD) card, a flash card, etc. Further, the memory 81 may also include both an internal storage unit of the computer equipment 8 and an external storage device. The memory 81 is configured to store an operation system, an application program, a boot loader, data and other programs, such as the program code of the computer program. The memory 81 may also be used to temporarily store data that has been output or will be output.

The embodiment of the present application also provides a computer-readable storage medium, the computer-readable storage medium stores a computer program, and when the computer program is executed by a processor, the steps in each of the foregoing method embodiments can be performed.

An embodiment of the present application provides a computer program product. When the computer program product is executed on computer equipment, the computer equipment is enabled to implement the steps in the foregoing method embodiments.

The above-described embodiments are only used to illustrate the technical solutions of the present application, rather than being intended to limit the present application. Although the present application has been described in detail with reference to the foregoing embodiments, it would be understood by those of ordinary skill in the art that the technical solutions described in the foregoing embodiments may still be modified or some of the technical features in the technical solutions may be equivalently substituted. These modifications or substitutions do not make the essence of the corresponding technical solutions deviate from the spirit and scope of the technical solutions of various embodiments of the present application, and should all be included within the protection scope of the present application.

1. A method for a chip layout, comprising:
determining external interfaces and internal interfaces of a chip, and each of the internal interfaces being a port of a component of the chip;
constructing, according to the external interfaces and the internal interfaces, an objective function, and the objective function being applied to describe a wiring length of the chip;
determining, through a preset genetic algorithm, a target value of the objective function, and the target value being applied to determine a first layout diagram of the chip;
determining, based on an operation temperature of an internal chip as the component of the chip, a second layout diagram of the chip; and
performing an image fusion on the first layout diagram and the second layout diagram to obtain a target layout diagram of the chip.

2. The method according to claim 1, wherein said constructing, according to the external interfaces and the internal interfaces, the objective function, comprises:
constructing a quasi-microphone array model by using each of the internal interfaces as an internal moving point and using each of the external interfaces as an edge fixed point; and
establishing the objective function based on a sound receiving time between the edge fixed point and the internal moving point in the quasi-microphone array model.

3. The method according to claim 2, wherein the objective function is expressed as:
$$F = {\sum }_{j = 1}^{n} {H}_{j} {\sum }_{i = 1}^{n} Kji τ ji \\ τ ji = \frac{\sqrt{{( Xja - Xib )}^{2} + {( YjA - Yib )}^{2}}}{c}$$
wherein, F is the objective function; Kji is a weighting coefficient of a j-th external interface and an i-th internal interface, and τji is a time duration lasting from a time when the j-th external interface sends out a sound to a time when the i-th internal interface receives the sound; (XjA, YjA) is a fixed-point coordinate of the j-th external interface, (Xib, Yib) is a moving-point coordinate of the i-th internal interface, c is a speed of sound; Hⱼ is an utilization rate of the j-th external interface.

4. The method according to claim 2, wherein said determining, through the preset genetic algorithm, the target value of the objective function, and the target value being applied to determine the first layout diagram of the chip, comprises:
establishing an initial population of the genetic algorithm by taking the component as an individual, and taking the port as a gene of the individual, wherein the genetic algorithm has a mutation probability and an iteration stop rule;
performing multiple mutations on the initial population according to the mutation probability and the iterative stop rule to obtain multiple intermediate populations;
calculating values of the objective function corresponding to the initial population and the multiple intermediate populations respectively;
taking a minimum value of the calculated values of the objective function as the target value;
determining, based on the target value, a moving-point coordinate corresponding to the port;
generating, based on the moving-point coordinate, the first layout diagram.

5. The method according to claim 1, wherein said determining, based on the operation temperature of the internal chip as the component of the chip, the second layout diagram of the chip comprises:
training a heterogeneous graph attention model;
determining, based on the operation temperature of the internal chip as the component of the chip and an initial position of the internal chip, input parameters of the heterogeneous graph attention model;
inputting the input parameters into the heterogeneous graph attention model to obtain a target position of the internal chip;
generating, according to the target position, the second layout diagram.

6. The method according to claim 1, wherein said performing the image fusion on the first layout diagram and the second layout diagram to obtain the target layout diagram of the chip comprises:
determining a first weighted value of the first layout diagram and a second weighted value of the second layout diagram;
determining a loss function of an image fusion model based on the first weighted value and the second weighted value;
performing multiple trainings on the image fusion model by using the first layout diagram and the second layout diagram to obtain multiple comprehensive layout diagrams;
calculating a loss value of the loss function after each of the multiple trainings; and
determining a comprehensive layout diagram corresponding to a minimum loss value as the target layout diagram.

7. The method according to claim 6, wherein said performing multiple trainings on the image fusion model by using the first layout diagram and the second layout diagram to obtain multiple comprehensive layout diagrams comprises:
performing a feature channel expansion on the first layout diagram and the second layout diagram to obtain a first target feature map and a second target feature map;
extracting, by using an encoder in the image fusion model, a first feature and a second feature from the first target feature map and the second target feature map, respectively;
performing a fusion on the first feature and the second feature to obtain a fusion feature; and
inputting the fusion feature into a decoder in the image fusion model to obtain the a comprehensive layout diagram after fusion.

8. Computer equipment, comprising a memory, a processor, and a computer program stored in the memory and executable by the processor, wherein the processor, when executing the computer program, is configured to perform operations that comprise:
determining external interfaces and internal interfaces of a chip, and each of the internal interfaces being a port of a component of the chip;
constructing, according to the external interfaces and the internal interfaces, an objective function, and the objective function being applied to describe a wiring length of the chip;
determining, through a preset genetic algorithm, a target value of the objective function, and the target value being applied to determine a first layout diagram of the chip;
determining, based on an operation temperature of an internal chip as the component of the chip, a second layout diagram of the chip; and
performing an image fusion on the first layout diagram and the second layout diagram to obtain a target layout diagram of the chip.

9. A non-transitory computer-readable storage medium in which a computer program being stored, wherein the computer program, when executed by a processor, causes the processor to perform operations that comprise
determining external interfaces and internal interfaces of a chip, and each of the internal interfaces being a port of a component of the chip;
constructing, according to the external interfaces and the internal interfaces, an objective function, and the objective function being applied to describe a wiring length of the chip;
determining, through a preset genetic algorithm, a target value of the objective function, and the target value being applied to determine a first layout diagram of the chip;
determining, based on an operation temperature of an internal chip as the component of the chip, a second layout diagram of the chip; and
performing an image fusion on the first layout diagram and the second layout diagram to obtain a target layout diagram of the chip.

10. The computer equipment according to claim 8, wherein the operation of constructing, according to the external interfaces and the internal interfaces, the objective function, comprises:
constructing a quasi-microphone array model by using each of the internal interfaces as an internal moving point and using each of the external interfaces as an edge fixed point; and
establishing the objective function based on a sound receiving time between the edge fixed point and the internal moving point in the quasi-microphone array model.

11. The computer equipment according to claim 10, wherein the objective function is expressed as:
$$F = {\sum }_{j = 1}^{n} {H}_{j} {\sum }_{i = 1}^{n} Kji τ ji \\ τ ji = \frac{\sqrt{{( XjA - Xib )}^{2} + {( YjA - Yib )}^{2}}}{c}$$
wherein, F is the objective function; Kji is a weighting coefficient of a j-th external interface and an i-th internal interface, and τji is a time duration lasting from a time when the j-th external interface sends out a sound to a time when the i-th internal interface receives the sound; (XjA, YjA) is a fixed-point coordinate of the j-th external interface, (Xib, Yib) is a moving-point coordinate of the i-th internal interface, c is a speed of sound; Hⱼ is an utilization rate of the j-th external interface.

12. The computer equipment according to claim 10, wherein the operation of determining, through the preset genetic algorithm, the target value of the objective function, and the target value being applied to determine the first layout diagram of the chip, comprises:
establishing an initial population of the genetic algorithm by taking the component as an individual, and the port as a gene of the individual, wherein the genetic algorithm has a mutation probability and an iteration stop rule;
performing multiple mutations on the initial population according to the mutation probability and the iterative stop rule to obtain multiple intermediate populations;
calculating values of the objective function corresponding to the initial population and the multiple intermediate populations respectively;
taking a minimum value of the calculated values of the objective function as the target value;
determining, based on the target value, a moving-point coordinate corresponding to the port;
generating, based on the moving-point coordinate, the first layout diagram.

13. The computer equipment according to claim 8, wherein the operation of determining, based on the operation temperature of the internal chip as the component of the chip, the second layout diagram of the chip comprises:
training a heterogeneous graph attention model;
determining, based on the operation temperature of the internal chip as the component of the chip and an initial position of the internal chip, input parameters of the heterogeneous graph attention model;
inputting the input parameters into the heterogeneous graph attention model to obtain a target position of the internal chip;
generating, according to the target position, the second layout diagram.

14. The computer equipment according to claim 8, wherein the operation of performing the image fusion on the first layout diagram and the second layout diagram to obtain the target layout diagram of the chip comprises:
determining a first weighted value of the first layout diagram and a second weighted value of the second layout diagram;
determining a loss function of an image fusion model based on the first weighted value and the second weighted value;
performing multiple trainings on the image fusion model by using the first layout diagram and the second layout diagram to obtain multiple comprehensive layout diagrams;
calculating a loss value of the loss function after each of the multiple trainings; and
determining a comprehensive layout diagram corresponding to a minimum loss value as the target layout diagram.

15. The computer equipment according to claim 14, wherein the operation of performing multiple trainings on the image fusion model by using the first layout diagram and the second layout diagram to obtain multiple comprehensive layout diagrams comprises:
performing a feature channel expansion on the first layout diagram and the second layout diagram to obtain a first target feature map and a second target feature map;
extracting, by using an encoder in the image fusion model, a first feature and a second feature from the first target feature map and the second target feature map, respectively;
performing a fusion on the first feature and the second feature to obtain a fusion feature; and
inputting the fusion feature into a decoder in the image fusion model to obtain a comprehensive layout diagram after fusion.

16. The non-transitory computer-readable storage medium according to claim 9, wherein the operation of constructing, according to the external interfaces and the internal interfaces, the objective function, comprises:
constructing a quasi-microphone array model by using each of the internal interfaces as an internal moving point and using each of the external interfaces as an edge fixed point; and
establishing the objective function based on a sound receiving time between the edge fixed point and the internal moving point in the quasi-microphone array model.

17. The non-transitory computer-readable storage medium according to claim 16, wherein the objective function is expressed as:
$$F = {\sum }_{j = 1}^{n} {H}_{j} {\sum }_{i = 1}^{n} Kji τ ji \\ τ ji = \frac{\sqrt{{( XjA - Xib )}^{2} + {( YjA - Yib )}^{2}}}{c}$$
wherein, F is the objective function; Kji is a weighting coefficient of a j-th external interface and an i-th internal interface, and τji is a time duration lasting from a time when the j-th external interface sends out a sound to a time when the i-th internal interface receives the sound; (XjA, YjA) is a fixed-point coordinate of the j-th external interface, (Xib, Yib) is a moving-point coordinate of the i-th internal interface, c is a speed of sound; Hⱼ is an utilization rate of the j-th external interface.

18. The non-transitory computer-readable storage medium according to claim 16, wherein the operation of determining, through the preset genetic algorithm, the target value of the objective function, and the target value being applied to determine the first layout diagram of the chip, comprises:
establishing an initial population of the genetic algorithm by taking the component as an individual, and the port as a gene of the individual, wherein the genetic algorithm has a mutation probability and an iteration stop rule;
performing multiple mutations on the initial population according to the mutation probability and the iterative stop rule to obtain multiple intermediate populations;
calculating values of the objective function corresponding to the initial population and the multiple intermediate populations respectively;
taking a minimum value of the calculated values of the objective function as the target value;
determining, based on the target value, a moving-point coordinate corresponding to the port;
generating, based on the moving-point coordinate, the first layout diagram.

19. The non-transitory computer-readable storage medium according to claim 9, wherein the operation of determining, based on the operation temperature of the internal chip as the component of the chip, the second layout diagram of the chip comprises:
training a heterogeneous graph attention model;
determining, based on the operation temperature of the internal chip as the component of the chip and an initial position of the internal chip, input parameters of the heterogeneous graph attention model;
inputting the input parameters into the heterogeneous graph attention model to obtain a target position of the internal chip;
generating, according to the target position, the second layout diagram.

20. The non-transitory computer-readable storage medium according to claim 9, wherein the operation of performing the image fusion on the first layout diagram and the second layout diagram to obtain the target layout diagram of the chip comprises:
determining a first weighted value of the first layout diagram and a second weighted value of the second layout diagram;
determining a loss function of an image fusion model based on the first weighted value and the second weighted value;
performing multiple trainings on the image fusion model by using the first layout diagram and the second layout diagram to obtain multiple comprehensive layout diagrams;
calculating a loss value of the loss function after each of the multiple trainings; and
determining a comprehensive layout diagram corresponding to a minimum loss value as the target layout diagram.
